(19) United States
(12) Patent Application Publication
(10) Pub. No.: US 2026/0270249 A1
(43) Pub. Date: Sep. 10, 2026

(54) ENCRYPTED TRANSMISSION METHOD AND DATA STORAGE SYSTEM

(71) Applicant: Hefei Kaimeng Technology Co., Ltd., Anhui (CN)

(72) Inventors: Youping Ding, Anhui (CN); Xuhui Cheng, Anhui (CN)

(73) Assignee: Hefei Kaimeng Technology Co., Ltd., Anhui (CN)

(21) Appl. No.: 19/666,341

(22) Filed: May 3, 2026

(30) Foreign Application Priority Data
Jul. 18, 2025 (CN) 202510992819.9

(51) Int. Cl. H04L 9/40

(52) U.S. Cl. CPC H04L 63/0442; H04L 63/06

(57) ABSTRACT

Provided are an encrypted transmission method and a data storage system. The method includes the following. Multiple random data blocks and an encryption table are read from a storage device. A logical operation is performed on the random data blocks according to the encryption table to obtain encrypted information. Key information is encrypted according to the encrypted information to obtain encrypted key information. The key information is used to encrypt or decrypt data transmitted between a host system and the storage device. The encrypted key information is transmitted to the storage device.

### CROSS-REFERENCE TO RELATED APPLICATION

This application claims the priority benefit of China application serial no. 202510992819.9, filed on July 18, 2025. The entirety of the above-mentioned patent application is hereby incorporated by reference herein and made a part of this specification.

### BACKGROUND

### TECHNICAL FIELD

The disclosure relates to a field of storage technology, and more particularly, to an encrypted transmission method and a data storage system.

### DESCRIPTION OF RELATED ART

In order to ensure the security of data transmitted between a host system and a storage device, some types of data storage systems may support encryption of data transmitted between the host system and the storage device. However, in order to achieve the above function, key information used for data encryption and decryption is required to be exchanged between the host system and the storage device, thereby increasing the risk of the key information being intercepted, monitored, and/or stolen during transmission between the host system and the storage device. Once the aforementioned key information is obtained by a hacker, any encryption mechanism for the transmitted data will lose its meaning.

### SUMMARY

The disclosure provides an encrypted transmission method and a data storage system, which may effectively improve security of key information exchanged between a host system and a storage device, thereby significantly reducing a risk of data stored in the storage device being stolen.

An embodiment of the disclosure provides an encrypted transmission method for a host system. The encrypted transmission method includes the following. Multiple random data blocks and an encryption table are read from a storage device. A logical operation is performed on the random data blocks according to the encryption table to obtain encrypted information. Key information is encrypted according to the encrypted information to obtain an encrypted key. The key information is used to encrypt or decrypt data transmitted between the host system and the storage device. The encrypted key information is transmitted to the storage device.

An embodiment of the disclosure further provides an encrypted transmission method for a storage device. The encrypted transmission method including the following. An encrypted key information is obtained from a host system. A logical operation is performed on multiple random data blocks according to an encryption table to obtain encrypted information. The encrypted key information is decrypted according to the encrypted information to obtain key information. Data transmitted between the host system and the storage device is encrypted or decrypted based on the key information.

An embodiment of the disclosure further provides a data storage system, including a host system and a storage device. The storage device is connected to the host system. The host system is used to: read multiple random data blocks and an encryption table from the storage device; perform a logical operation on the random data blocks according to the encryption table to obtain encrypted information; encrypt key information according to the encrypted information to obtain encrypted key information, in which the key information is used to encrypt or decrypt data transmitted between the host system and the storage device; and transmit the encrypted key information to the storage device.

An embodiment of the disclosure further provides a data storage system, including a host system and a storage device. The storage device is connected to the host system. The storage device is used to: obtain an encrypted key information from the host system; perform a logical operation on multiple random data blocks according to an encryption table to obtain encrypted information; decrypt the encrypted key information according to the encrypted information to obtain key information; and encrypt or decrypt data transmitted between the host system and the storage device based on the key information.

Based on the above, the encrypted information may be synchronously generated at the host system side and the storage device side based on the random data blocks and the encryption table, and then used to encrypt and decrypt the key information transmitted between the host system and the storage device. Thus, the key information is protected through the encrypted information synchronously generated at the host system side and the storage device side, which may effectively improve the security of the key information exchanged between the host system and the storage device.

### BRIEF DESCRIPTION OF THE DRAWINGS

FIG. 1 is a schematic view of a data storage system according to an embodiment of the disclosure.

FIG. 2 is a schematic view illustrating a host system and a storage device synchronously obtaining encrypted information according to random data blocks and an encryption table according to an embodiment of the disclosure.

FIG. 3 is a schematic view illustrating generation of encrypted information by sequentially performing multiple sub-logical operations on multiple random data blocks according to an embodiment of the disclosure.

FIG. 4 is a schematic view illustrating a host system generating first encrypted key information according to an embodiment of the disclosure.

FIG. 5 is a schematic view illustrating a host system generating second encrypted key information according to an embodiment of the disclosure.

FIG. 6 is a schematic view illustrating a storage device restoring first key information according to an embodiment of the disclosure.

FIG. 7 is a schematic view illustrating a storage device restoring second key information according to an embodiment of the disclosure.

FIG. 8 is a flowchart of an encrypted transmission method according to an embodiment of the disclosure.

FIG. 9 is a flowchart of an encrypted transmission method according to an embodiment of the disclosure.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts.

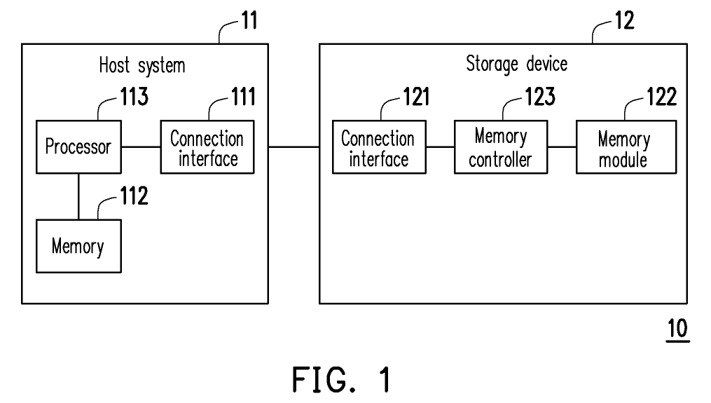

FIG. 1 is a schematic view of a data storage system according to an embodiment of the disclosure. Referring to FIG. 1, a data storage system 10 includes a host system 11 and a storage device 12. The storage device 12 may be connected to the host system 11 and may be used to store data from the host system 11. For example, the host system 11 may be a smartphone, a tablet computer, a notebook computer, a desktop computer, an industrial computer, a game console, a server, or a computer system disposed in a specific carrier (such as a vehicle, an aircraft, or a vessel), and a type of the host system 11 is not limited thereto. In addition, the storage device 12 may be a solid-state drive, a USB flash drive, a memory card, or other types of non-volatile storage devices.

In one embodiment, the host system 11 may include a connection interface 111, a memory 112, and a processor 113. The connection interface 111 is used to connect the host system 11 to the storage device 12. For example, the connection interface 111 may support an embedded multi-media card (eMMC), universal flash storage (UFS), peripheral component interconnect express (PCI Express), non-volatile memory express (NVM express), serial advanced technology attachment (SATA), universal serial bus (USB), or other types of connection interface standards. Therefore, the host system 11 may communicate with the storage device 12 through the connection interface 111 (e.g., exchange signals, commands, and/or data).

The memory 112 (also referred to as a buffer memory) is used to buffer the data. For example, the memory 112 may include a dynamic random access memory (DRAM), static random access memory (SRAM), or other types of memory.

The processor 113 is connected to the connection interface 111 and the memory 112. The processor 113 may be regarded as a control core of the host system 11 and is used to control the host system 11. For example, the processor 113 may be used to control or manage overall or partial operations of the host system 11. For example, the processor 113 may include a central processing unit (CPU), or other programmable general-purpose or special-purpose microprocessors, digital signal processors (DSP), programmable controllers, application specific integrated circuits (ASIC), programmable logic devices (PLD), other similar devices, or a combination of these devices.

In one embodiment, the host system 11 may further include other types of electronic circuits, such as a network interface card, a power management circuit, a display, a mouse, a keyboard, and/or a speaker, depending on practical requirements. In addition, in the following embodiments, the description of operations of the processor 113 may be equivalent to the description of the operations of the host system 11.

In one embodiment, the storage device 12 includes a connection interface 121, a memory module 122, and a memory controller 123. The connection interface 121 is used to connect the storage device 12 to the host system 11. For example, the connection interface 121 may support eMMC, UFS, PCI Express, NVM express, SATA, USB, or other types of connection interface standards. Therefore, the storage device 12 may communicate with the host system 11 through the connection interface 121 (e.g., exchange signals, commands, and/or data).

The memory module 122 is used to store the data. For example, the memory module 122 may include one or more rewritable non-volatile memory modules. Each of the rewritable non-volatile memory modules may include one or more storage unit arrays. Storage units in the storage unit array store the data in a form of voltages (also referred to as threshold voltages). For example, the memory module 122 may include a single level cell (SLC) NAND flash memory module, a multi level cell (MLC) NAND flash memory module, a triple level cell (TLC) NAND flash memory module, a quad level cell (QLC) NAND flash memory module, and/or other memory modules with the same or similar characteristics.

The memory controller 123 is connected to the connection interface 121 and the memory module 122. The memory controller 123 may be regarded as a control core of the storage device 12 and is used to control the storage device 12. For example, the memory controller 123 may be used to control or manage overall or partial operations of the storage device 12. For example, the memory controller 123 may include a CPU, or other programmable general-purpose or special-purpose microprocessors, DSPs, programmable controllers, ASICs, PLDs, other similar devices, or a combination of these devices. In one embodiment, the memory controller 123 may include a flash memory controller. In addition, in the following embodiments, the description of operations of the memory controller 123 may be equivalent to the description of the operations of the storage device 12.

In one embodiment, the memory controller 123 may send a command sequence to the memory module 122 to access the memory module 122. For example, the memory controller 123 may send a write command sequence to the memory module 122 to instruct the memory module 122 to store the data into specific storage units. The memory controller 123 may send a read command sequence to the memory module 122 to instruct the memory module 122 to read the data from specific storage units. The memory controller 123 may send an erase command sequence to the memory module 122 to instruct the memory module 122 to erase the data stored in specific storage units. In addition, the memory controller 123 may further send other types of command sequences to the memory module 122 to instruct the memory module 122 to perform other types of operations, depending on the practical requirements. Correspondingly, the memory module 122 may receive the command sequence from the memory controller 123. The memory module 122 may access the storage units inside the memory module 122 or perform other operations according to the received command sequence.

In one embodiment, the processor 113 may send a public key for an asymmetric encryption algorithm to the storage device 12, and information encrypted using asymmetric encryption may only be decrypted by a corresponding private key. The storage device 12 may perform the asymmetric encryption by using use the public key and then transmit the information, and after the processor 113 receives the information encrypted by using the public key for the asymmetric encryption, the processor 113 may perform decryption by using the private key corresponding to the public key.

In one embodiment, the processor 113 may send a command (also referred to as a configuration command) to the storage device 12. The configuration command is used to instruct the storage device 12 to automatically generate multiple random data blocks and an encryption table. Each of the random data blocks includes a piece of random data. The random data included in the random data blocks may each be different from one another. In addition, the encryption table may be used to record operation information related to the random data blocks. For example, the operation information may include inter-block operation rules corresponding to the random data blocks. In response to the configuration command, the memory controller 123 may automatically generate the random data blocks and the encryption table.

In one embodiment, the processor 113 may read the aforementioned random data blocks and encryption table that have been asymmetrically encrypted from the storage device 12. For example, the processor 113 may send a command (also referred to as an advanced read command) to the storage device 12. The advanced read command may be used to instruct the storage device 12 to provide the aforementioned random data blocks and encryption table. In response to the advanced read command, the memory controller 123 may transmit the aforementioned random data blocks and encryption table that have been asymmetrically encrypted to the host system 11.

In one embodiment, the aforementioned configuration command and advanced read command both belong to special control commands issued by the host system 11. A command format of the special control command is different from the general read command, write command, or erase command issued by the host system 11. For example, the aforementioned configuration command may carry the following fields and contents thereof: “Command = IF-RECV”, “Protocal ID = 02”, “Transfer Length = Non-zero”, “ComID = 0x0007”, and “NSID = Namespace ID”. In addition, the aforementioned advanced read command may carry the following fields and contents thereof: “Command = IF-RECV”, “Protocal ID = 02”, “Transfer Length = Non-zero”, “ComID = 0x0008”, and “NSID = Namespace ID”. It should be noted that the command formats of the aforementioned configuration command and advanced read command may also be adjusted according to the practical requirements.

In one embodiment, the processor 113 may perform the decryption (i.e., asymmetric decryption) on the received aforementioned random data blocks and encryption table that have been asymmetrically encrypted through the aforementioned private key, so as to obtain (e.g., restore) the unencrypted aforementioned random data blocks and encryption table.

In one embodiment, after obtaining the aforementioned random data blocks and encryption table, the processor 113 may perform a logical operation on the aforementioned random data blocks according to the aforementioned encryption table, so as to obtain encrypted information. For example, the processor 113 may determine multiple inter-block operation rules according to the aforementioned encryption table. Then, the processor 113 may sequentially perform multiple logical operations (also referred to as sub-logical operations) on the aforementioned random data blocks according to the inter-block operation rules, so as to obtain the aforementioned encrypted information.

In one embodiment, the aforementioned inter-block operation rules may be used to specify (or define) types of the aforementioned sub-logical operations. Each of the inter-block operation rules may be used to specify (or define) the type of one of the aforementioned sub-logical operations. For example, the i-th inter-block operation rule among the aforementioned inter-block operation rules may be used to specify (or define) the type of the i-th sub-logical operation among the aforementioned sub-logical operations. For example, the type of each of the sub-logical operations may be an AND operation, an OR operation, a NOR operation, an XOR operation, or other operations. In addition, assuming that the total number of the aforementioned random data blocks is n, the total number of the aforementioned inter-block operation rules may be n-1.

In one embodiment, the processor 113 may perform one sub-logical operation (also referred to as a first sub-logical operation) on a certain random data block (also referred to as a first random data block) and another random data block (also referred to as a second random data block) among the aforementioned random data blocks according to a certain inter-block operation rule (also referred to as a first inter-block operation rule) among the aforementioned inter-block operation rules, so as to obtain an intermediate block (also referred to as a first intermediate block). For example, the data in the first intermediate block may reflect an operation result of performing the first sub-logical operation on the random data in the first random data block and the random data in the second random data block.

After obtaining the first intermediate block, the processor 113 may perform at least one sub-logical operation (also referred to as a second sub-logical operation) on the first intermediate block and at least one random data block among the aforementioned random data blocks (also referred to as a third random data block) according to at least one inter-block operation rule (also referred to as a second inter-block operation rule) among the aforementioned inter-block operation rules, so as to obtain the encrypted information. It should be noted that the total number of the third random data blocks may be one or more, depending on the practical requirements.

In one embodiment, after generating the aforementioned random data blocks and encryption table, the memory controller 123 may also perform the logical operation on the aforementioned random data blocks according to the encryption table, so as to obtain the encrypted information. For example, the memory controller 123 may determine the aforementioned inter-block operation rules according to the aforementioned encryption table. Then, the memory controller 123 may sequentially perform the sub-logical operations on the aforementioned random data blocks according to the inter-block operation rules, so as to obtain the encrypted information.

It should be noted that the memory controller 123 and the processor 113 obtain the required encrypted information based on the same seed (e.g., the aforementioned random data blocks and encryption table). Therefore, the encrypted information obtained by the memory controller 123 may be the same as the aforementioned encrypted information obtained by the processor 113. For example, information content of the encrypted information obtained by the memory controller 123 may be the same as information content of the aforementioned encrypted information obtained by the processor 113.

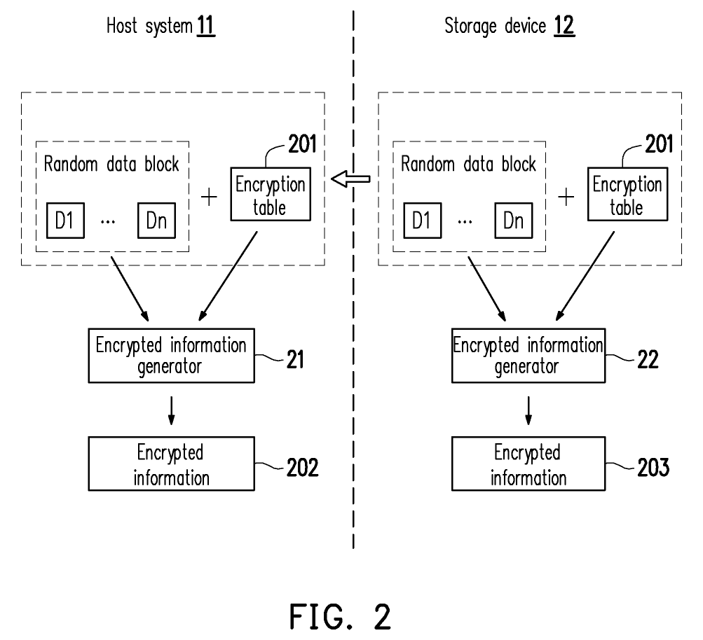

FIG. 2 is a schematic view illustrating a host system and a storage device synchronously obtaining encrypted information according to random data blocks and an encryption table according to an embodiment of the disclosure. Referring to FIG. 2, assuming that the processor 113 includes an encrypted information generator 21, and the memory controller 123 includes an encrypted information generator 22. The encrypted information generators 21 and 22 may be implemented by software, firmware, and/or hardware.

After automatically generating random data blocks D1 to Dn and an encryption table 201, the memory controller 123 may transmit the random data blocks D1 to Dn and the encryption table 201 to the host system 11. After receiving the random data blocks D1 to Dn and the encryption table 201, the encrypted information generator 21 in the host system 11 may automatically generate encrypted information 202 according to the random data blocks D1 to Dn and the encryption table 201. On the other hand, the encrypted information generator 22 in the storage device 12 may also automatically generate encrypted information 203 according to the random data blocks D1 to Dn and the encryption table 201. Information content of the encrypted information 202 may be the same as information content of the encrypted information 203.

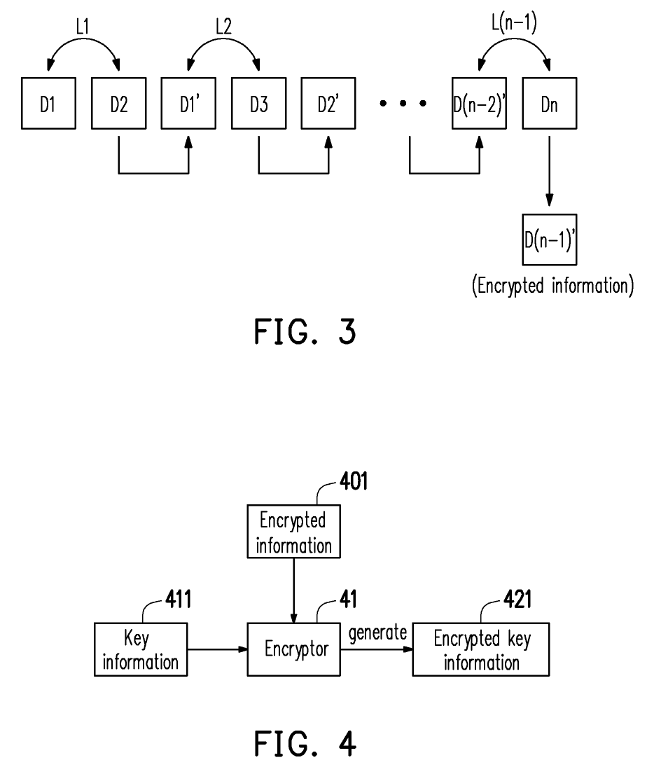

FIG. 3 is a schematic view illustrating generation of encrypted information by sequentially performing multiple sub-logical operations on multiple random data blocks according to an embodiment of the disclosure. Referring to FIG. 2 and FIG. 3, taking the encrypted information generator 21 as an example, based on the encryption table 201, the encrypted information generator 21 may determine n-1 inter-block operation rules. Based on the n-1 inter-block operation rules, the encrypted information generator 21 may sequentially perform sub-logical operations L1 to L(n-1) on the random data blocks D1 to Dn, so as to obtain the required encrypted information. Each of the sub-logical operations may respectively include the aforementioned AND operation, OR operation, NOR operation, XOR operation, or other operations.

Specifically, according to the first inter-block operation rule among the aforementioned n-1 inter-block operation rules, the encrypted information generator 21 may perform the sub-logical operation L1 on the random data blocks D1 and D2, so as to obtain an intermediate block D1’. The data contained in the intermediate block D1’ may reflect an operation result of the encrypted information generator 21 performing the sub-logical operation L1 on the random data blocks D1 and D2.

After obtaining the intermediate block D1’, according to the second inter-block operation rule among the aforementioned n-1 inter-block operation rules, the encrypted information generator 21 may perform the sub-logical operation L2 on the intermediate block D1’ and the random data block D3, so as to obtain an intermediate block D2’. The data contained in the intermediate block D2’ may reflect an operation result of the encrypted information generator 21 performing the sub-logical operation L2 on the intermediate block D1’ and the random data block D3.

By analogy, after obtaining an intermediate block D(n-2)’, according to the last inter-block operation rule among the aforementioned n-1 inter-block operation rules, the encrypted information generator 21 may perform the sub-logical operation L(n-1) on the intermediate block D(n-2)’ and the random data block Dn, so as to obtain an intermediate block D(n-1)’. The data contained in the intermediate block D(n-1)’ may reflect an operation result of the encrypted information generator 21 performing the sub-logical operation L(n-1) on the intermediate block D(n-2)’ and the random data block Dn. Then, the encrypted information generator 21 may obtain the encrypted information 202 according to the data contained in the intermediate block D(n-1)’. For example, the encrypted information generator 21 may directly determine the data contained in the intermediate block D(n-1)’ as the encrypted information 202. Alternatively, the encrypted information generator 21 may perform operations such as formatting or other logical operations on the data contained in the intermediate block D(n-1)’ to obtain the encrypted information 202.

It should be noted that the encrypted information generator 22 may also obtain the encrypted information 203 by referring to the operations described in the embodiment of FIG. 3, and details will not be repeated here. In addition, if the information recorded in the encryption table 201 reflects other types of operation rules, the memory controller 123 and the processor 113 may also process the random data blocks D1 to Dn in other ways to obtain the required encrypted information 202 and 203, and details will not be described one by one here.

In one embodiment, after obtaining the aforementioned encrypted information, the processor 113 may encrypt key information according to the encrypted information, so as to obtain key information that has been encrypted (also referred to as an encrypted key or encrypted key information). The key information may be used to encrypt or decrypt the data transmitted between the host system 11 and the storage device 12 (e.g., user data or other key information). Then, the processor 113 may transmit the encrypted key information to the storage device 12.

In one embodiment, the memory controller 123 may obtain the aforementioned encrypted key information from the host system 11. The memory controller 123 may decrypt the encrypted key information according to the aforementioned encrypted information, so as to obtain (i.e., restore) the aforementioned key information. Thereafter, the memory controller 123 may encrypt or decrypt the data transmitted between the host system 11 and the storage device 12 based on the key information. Similarly, the processor 113 may also encrypt or decrypt the data transmitted between the host system 11 and the storage device 12 based on the key information.

In one embodiment, the aforementioned key information includes a certain type of key information (also referred to as first key information). The first key information may be used (or dedicated) to encrypt (and decrypt) another type of key information (also referred to as second key information). In addition, the second key information may be used (or dedicated) to encrypt or decrypt the user data transmitted between the host system 11 and the storage device 12. For example, the first key information may include a key encryption key (KEK), and the second key information may include a media encryption key (MEK).

In one embodiment, after obtaining the aforementioned encrypted information, the processor 113 may encrypt the first key information according to the encrypted information, so as to obtain the encrypted key information (also referred to as first encrypted key information). Then, the processor 113 may transmit the first encrypted key information to the storage device 12.

FIG. 4 is a schematic view illustrating a host system generating first encrypted key information according to an embodiment of the disclosure. Referring to FIG. 4, assume that the processor 113 includes an encryptor 41. In the host system 11, the encryptor 41 may encrypt key information 411 (i.e., the first key information) according to encrypted information 401, so as to generate encrypted key information 421 (i.e., the first encrypted key information). It should be noted that the encryptor 41 may adopt various encryption and decryption algorithms such as advanced encryption standard (AES), elliptic curve encryption (ECE), or one-time pad (OTP), and details will not be described one by one here.

In one embodiment, the aforementioned key information may further include the second key information. In one embodiment, after obtaining the aforementioned encrypted information, the processor 113 may encrypt the second key information according to the encrypted information and the first key information, so as to obtain the encrypted key information (also referred to as second encrypted key information). Then, the processor 113 may transmit the second encrypted key information to the storage device 12.

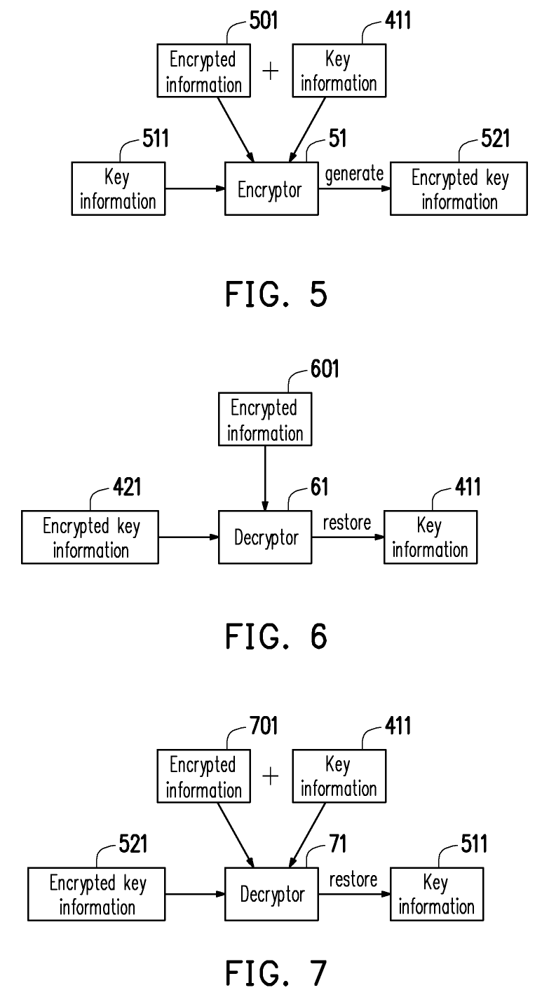

FIG. 5 is a schematic view illustrating a host system generating second encrypted key information according to an embodiment of the disclosure. Referring to FIG. 5, assuming that the processor 113 includes an encryptor 51. In the host system 11, the encryptor 51 may encrypt key information 511 (i.e., the second key information) according to encrypted information 501 and the key information 411, so as to generate encrypted key information 521 (i.e., the second encrypted key information). It should be noted that the encryptor 51 may also adopt various encryption and decryption algorithms such as AES, ECE, or OTP, and details will not be described one by one here.

In one embodiment, after obtaining the first encrypted key information from the host system 11, according to the aforementioned encrypted information, the memory controller 123 may decrypt the first encrypted key information, so as to obtain (i.e., restore) the first key information. Thereafter, the memory controller 123 may further decrypt the second encrypted key information from the host system 11 based on the first key information, so as to obtain (i.e., restore) the second key information.

FIG. 6 is a schematic view illustrating a storage device restoring first key information according to an embodiment of the disclosure. Referring to FIG. 6, assuming that the memory controller 123 includes a decryptor 61. After receiving the encrypted key information 421 (i e., the first encrypted key information) from the host system 11, in the storage device 12, the decryptor 61 may decrypt the encrypted key information 421 according to encrypted information 601 (identical to the encrypted information 401 of FIG. 4), so as to obtain (i.e., restore) the key information 411 (i.e., the first key information). It should be noted that the decryptor 61 may also adopt various encryption and decryption algorithms such as AES, ECE, or OTP, and details will not be described one by one here.

In one embodiment, after obtaining the second encrypted key information from the host system 11, according to the aforementioned encrypted information and the first key information, the memory controller 123 may decrypt the second encrypted key information, so as to obtain (i.e., restore) the second key information. Thereafter, the memory controller 123 may encrypt or decrypt the user data transmitted between the host system 11 and the storage device 12 based on the second key information.

FIG. 7 is a schematic view illustrating a storage device restoring second key information according to an embodiment of the disclosure. Referring to FIG. 7, assuming that the memory controller 123 includes a decryptor 71. After receiving the encrypted key information 521 (i.e., the second encrypted key information) from the host system 11, in the storage device 12, the decryptor 71 may decrypt the encrypted key information 521 according to encrypted information 701 (identical to the encrypted information 501 of FIG. 5) and the key information 411 (i.e., the first key information), so as to obtain (i.e., restore) the key information 511 (i.e., the second key information). It should be noted that the decryptor 71 may also adopt various encryption and decryption algorithms such as AES, ECE, or OTP, and details will not be described one by one here. Thereafter, the memory controller 123 may encrypt or decrypt the user data transmitted between the host system 11 and the storage device 12 according to the key information 511 (i.e., the second key information).

It should be noted that, in the embodiments of FIG. 4 and FIG. 6, the encryption algorithm adopted by the encryptor 41 located in the host system 11 and the decryption algorithm adopted by the decryptor 61 located in the storage device 12 are mutually matched. Therefore, according to the same encrypted information (i.e., the encrypted information 401 and 601), the encryptor 41 and the decryptor 61 may respectively perform encryption and decryption (i.e., restoration) of the first key information (i.e., the key information 411).

Similarly, in the embodiments of FIG. 5 and FIG. 7, the encryption algorithm adopted by the encryptor 51 located in the host system 11 and the decryption algorithm adopted by the decryptor 71 located in the storage device 12 are mutually matched. Therefore, according to the same encrypted information (i.e., the encrypted information 501 and 701) and the same first key information (i.e., the key information 411), the encryptor 51 and the decryptor 71 may respectively perform encryption and decryption (i.e., restoration) of the second key information (i.e., the key information 511).

Traditionally, the host system often directly provides the key used for encrypting the data (e.g., the aforementioned second key information) to the storage device, which may cause the key to be intercepted or stolen during transmission, rendering the subsequent encryption mechanism ineffective.

However, through the dual-layer encryption key information transmission mechanism mentioned in the aforementioned embodiments, the random data blocks and the encryption table are securely transmitted via asymmetric encryption. Regardless of which transmission stage the hacker obtains the encrypted key information (i.e., the first encrypted key information or the second encrypted key information), since the hacker lacks the critical encrypted information, the hacker will inevitably be unable to successfully decrypt the correct key information in a short period of time. As a result, security of the key information exchanged between the host system and the storage device may be effectively enhanced, thereby significantly reducing a risk of the data stored in the storage device 12 being stolen. On the other hand, adopting symmetric encryption during data exchange may greatly reduce the time required for encryption and decryption compared to asymmetric encryption, while ensuring data security.

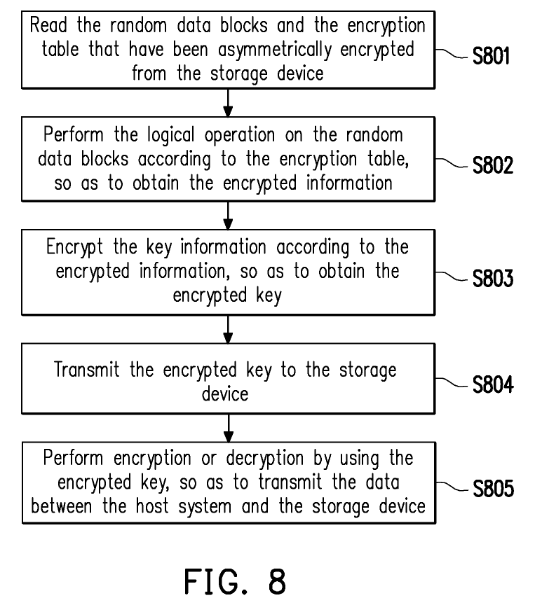

FIG. 8 is a flowchart of an encrypted transmission method according to an embodiment of the disclosure. Referring to FIG. 8, in step S801, the random data blocks and the encryption table that have been asymmetrically encrypted are read from the storage device. In step S802, the logical operation is performed on the random data blocks according to the encryption table, so as to obtain the encrypted information. In step S803, the key information is encrypted according to the encrypted information, so as to obtain the encrypted key. In step S804, the encrypted key information is transmitted to the storage device. In step S805, encryption or decryption is performed by using the encrypted key, so as to transmit the data between the host system and the storage device.

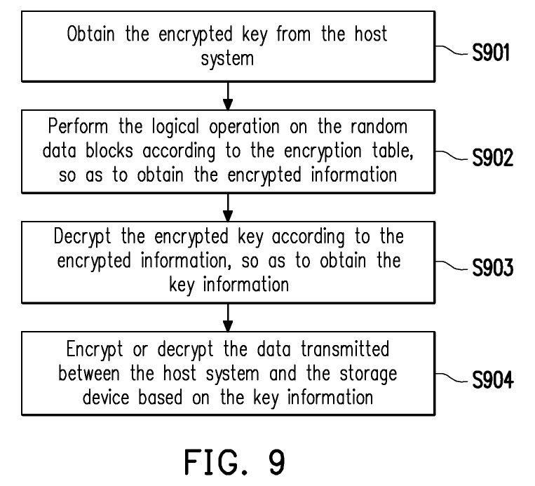

FIG. 9 is a flowchart of an encrypted transmission method according to an embodiment of the disclosure. Referring to FIG. 9, in step S901, the encrypted key is obtained from the host system. In step S902, the logical operation is performed on the random data blocks according to the encryption table, so as to obtain the encrypted information. In step S903, the encrypted key is decrypted according to the encrypted information, so as to obtain the key information. In step S904, the data transmitted between the host system and the storage device is encrypted or decrypted based on the key information.

However, the steps in FIG. 8 and FIG. 9 have been described in detail above, and will not be further repeated here. It is worth noting that the steps in FIG. 8 and FIG. 9 may be implemented as multiple program codes or circuits, and the disclosure is not limited thereto. In addition, the methods of FIG. 8 and FIG. 9 may be used in conjunction with the above exemplary embodiments, or may be used independently, and the disclosure is not limited thereto.

Based on the above, in the encrypted transmission method and the data storage system provided in the embodiments of the disclosure, the encrypted information is synchronously generated based on the random data blocks and the encryption table at both the host system side and the storage device side, and the encrypted information is then used for dual-layer encryption of the key information. As a result, the security of the key information exchanged between the host system and the storage device may be effectively enhanced, thereby significantly reducing the risk of the data stored in the storage device being stolen.

Finally, it should be noted that the above embodiments are only used to illustrate but not to limit the technical solutions of the disclosure. Although the disclosure has been described in detail with reference to the foregoing embodiments, persons skilled in the art should understand that they may still modify the technical solutions described in the foregoing embodiments or equivalently replace some or all of the technical features. However, the modifications or replacements do not cause the spirit of the corresponding technical solution to deviate from the scope of the technical solution according to each embodiment of the disclosure.

What is claimed is:

1. An encrypted transmission method for a host system, wherein the encrypted transmission method comprises:
reading, from a storage device, a plurality of random data blocks and an encryption table that have been asymmetrically encrypted;
performing a logical operation on the random data blocks according to the encryption table to obtain encrypted information;
encrypting key information according to the encrypted information to obtain an encrypted key;
transmitting the encrypted key to the storage device; and
performing encryption or decryption by using the encrypted key to transmit data between the host system and the storage device.

2. The encrypted transmission method according to claim 1, wherein performing the logical operation on the random data blocks according to the encryption table to obtain the encrypted information comprises:
determining a plurality of inter-block operation rules according to the encryption table; and
performing a plurality of sub-logical operations on the random data blocks sequentially according to the inter-block operation rules to obtain the encrypted information.

3. The encrypted transmission method according to claim 2, wherein the inter-block operation rules are used to specify types of the sub-logical operations.

4. The encrypted transmission method according to claim 2, wherein performing the sub-logical operations on the random data blocks sequentially according to the inter-block operation rules to obtain the encrypted information comprises:
performing a first sub-logical operation on a first random data block and a second random data block among the random data blocks according to a first inter-block operation rule among the inter-block operation rules to obtain a first intermediate block; and
performing a second sub-logical operation on the first intermediate block and a third random data block among the random data blocks according to a second inter-block operation rule among the inter-block operation rules to obtain the encrypted information.

5. The encrypted transmission method according to claim 1, wherein the key information comprises first key information, the encrypted key comprises a first encrypted key, and encrypting the key information according to the encrypted information to obtain the encrypted key comprises:
encrypting the first key information according to the encrypted information to obtain the first encrypted key,
wherein the first key information is used to encrypt second key information, and the second key information is used to encrypt or decrypt user data transmitted between the host system and the storage device.

6. The encrypted transmission method according to claim 5, wherein the key information further comprises the second key information, the encrypted key further comprises a second encrypted key, and encrypting the key information according to the encrypted information to obtain the encrypted key comprises:
encrypting the second key information according to the encrypted information and the first key information to obtain the second encrypted key.

7. The encrypted transmission method according to claim 1, further comprising:
sending a configuration command to the storage device to instruct the storage device to automatically generate the random data blocks and the encryption table.

8. The encrypted transmission method according to claim 1, further comprising:
sending an advanced read command to the storage device to instruct the storage device to provide the random data blocks and the encryption table.

9. An encrypted transmission method for a storage device, wherein the encrypted transmission method comprises:
obtaining an encrypted key from a host system;
performing a logical operation on a plurality of random data blocks according to an encryption table to obtain encrypted information;
decrypting the encrypted key according to the encrypted information to obtain key information; and
encrypting or decrypting data transmitted between the host system and the storage device based on the key information.

10. The encrypted transmission method according to claim 9, wherein performing the logical operation on the random data blocks according to the encryption table to obtain the encrypted information comprises:
determining a plurality of inter-block operation rules according to the encryption table; and
performing a plurality of sub-logical operations on the random data blocks sequentially according to the inter-block operation rules to obtain the encrypted information.

11. The encrypted transmission method according to claim 10, wherein the inter-block operation rules are used to specify types of the sub-logical operations.

12. The encrypted transmission method according to claim 10, wherein performing the sub-logical operations on the random data blocks sequentially according to the inter-block operation rules to obtain the encrypted information comprises:
performing a first sub-logical operation on a first random data block and a second random data block among the random data blocks according to a first inter-block operation rule among the inter-block operation rules to obtain a first intermediate block; and
performing a second sub-logical operation on the first intermediate block and a third random data block among the random data blocks according to a second inter-block operation rule among the inter-block operation rules to obtain the encrypted information.

13. The encrypted transmission method according to claim 9, wherein the key information comprises first key information, the encrypted key information comprises a first encrypted key, and decrypting the encrypted key information according to the encrypted information to obtain the key information comprises:
decrypting the first encrypted key according to the encrypted information to obtain the first key information,
wherein the first key information is used to encrypt second key information, and the second key information is used to encrypt or decrypt user data transmitted between the host system and the storage device.

14. The encrypted transmission method according to claim 13, wherein the key information further comprises the second key information, the encrypted key further comprises a second encrypted key, and decrypting the encrypted key according to the encrypted information to obtain the key information comprises:
decrypting the second encrypted key according to the encrypted information and the first key information to obtain the second key information.

15. The encrypted transmission method according to claim 9, further comprising:
automatically generating the random data blocks and the encryption table in response to a configuration command from the host system.

16. The encrypted transmission method according to claim 9, further comprising:
providing the random data blocks and the encryption table to the host system in response to an advanced read command from the host system.

17. A data storage system, comprising:
a host system; and
a storage device connected to the host system,
wherein the host system is used to:
read a plurality of random data blocks and an encryption table that have been asymmetrically encrypted from the storage device;
perform a logical operation on the random data blocks according to the encryption table to obtain encrypted information;
encrypt key information according to the encrypted information to obtain an encrypted key;
transmit the encrypted key to the storage device; and
perform encryption or decryption by using the encrypted key to transmit data between the host system and the storage device;
wherein the storage device is used to:
obtain an encrypted key from the host system;
perform a logical operation on a plurality of random data blocks according to an encryption table to obtain encrypted information;
decrypt the encrypted key according to the encrypted information to obtain key information; and
encrypt or decrypt data transmitted between the host system and the storage device based on the key information.
